(19) United States
(12) Patent Application Publication
(10) Pub. No.: US 2004/0109020 A1
(43) Pub. Date: Jun. 10, 2004

(54) Portable communication terminal having character font changing function and method for changing character font using the same

(75) Inventor: Soo-Rim Song, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., Kyungki-Do (KR)

(21) Appl. No.: 10/397,075

(22) Filed: Mar. 26, 2003

(30) Foreign Application Priority Data
Dec. 6, 2002 (KR) 2002-77279

(51) Int. Cl. G09G 5/00

(52) U.S. Cl. 345/744

(57) ABSTRACT

Disclosed herein is a portable communication terminal having a character font changing function. The portable communication terminal comprises a storage unit for storing font information for changing of a font of character data, a font changing unit for changing the font of the character data inputted or to be inputted on the basis of the font information in response to in inputted control signal, a display unit for displaying the font information and the character data of the font changed by the font changing unit on a screen, a communication unit for communicating with a destination device, the communicating unit sending the character data changed in font by the font changing unit and displayed on the screen to the destination device in response to an inputted control signal, and a controller for controlling the font changing unit in response to a font change command to change the font of the character data, and controlling a display operation of the display unit and a sending operation of the communication unit.

This application claims priority to an application entitled “PORTABLE COMMUNICATION TERMINAL HAVING CHARACTER FONT CHANGING FUNCTION AND METHOD FOR CHANGING CHARACTER FONT USING THE SAME”, filed in the Korean Industrial Property Office on Dec. 6, 2002 and assigned Serial No. 2002-77279, the contents of which are hereby incorporated by reference.

### BACKGROUND OF THE INVENTION

1. Field of the Invention

The present invention relates to a portable communication terminal and to a font changing method using the same, and more particularly to a portable communication terminal which is capable of changing the font of a character to be sent to a destination device, and a method for changing a character font using the same.

2. Description of the Related Art

With the rapid advance of the communication industry and the rapid growth of mobile communication services, mobile communication terminals (also referred to as portable communication terminals) have taken their position as a necessity of life. In order to meet users' various requests for improved functions, such portable communication terminals have a variety of functions in addition to basic mobile wireless telephone functions. Such additional functions may be, for example, a background picture setting function, a short message service (SMS) function, an MP3 function, a wireless Internet function, a camera function, a TV function, a VOD function, etc. Among these functions of the portable communication terminals, the short message service function of creating and sending or receiving message contents in a text form, a function of storing telephone numbers and names corresponding thereto, and a phonebook function of searching for and transmitting stored character data are associated with the processing of character data.

As the character data processing functions are increasingly used, the portable communication terminals process and display various types of character information so that users can recognize the character information. However, the portable communication terminals conventionally display only characters in fonts preset by manufacturers when processing and displaying character data. For this reason, although the portable communication terminal users frequently use the portable communication terminals as information processing devices and variously individualize their terminals, the portable communication terminals cannot help uniformly displaying processed characters in fonts set by manufacturers in manufacturing processes thereof, without diversely changing the fonts of the characters according to the users' desires.

At the present, the short message service function using the portable communication terminals is widely used for a chatting service where the users access specific servers and exchange messages with one another, as well as for a simple text service. In general, Internet chatting using personal computers (PCs) provides a variety of font styles, such as BatangChe, GungsuhChe, GulimChe, etc., and various font sizes and font colors, thereby enabling the users to selectively exhibit their various individualities by changing the fonts of inputted characters at any time.

Conventionally, the portable communication terminals are limited in their internal memory capacities and do not have standard fonts, such as fonts used in personal computers. For this reason, it is impossible for the users using a variety of additional services based on the portable communication terminals, such as a short message service, mail service, etc., to be provided with a variety of fonts, like their personal computer counterparts. In addition, in the present mobile terminals, character data of a short message or e-mail edited in various fonts is converted and displayed in the same font.

As a result, because the portable communication terminals do not have in common standard fonts, even though they provide a variety of fonts, when a sender sends a message of edited characters using the short message service or other additional service, a message recipient cannot help confirming the contents of the sent message in only a font provided by a manufacturing company of the corresponding terminal without consideration of the sender's individuality. Moreover, even though the users desire to emphasize, with respect to size and color, specific characters according to their preferences, the present portable communication terminals do not provide the capabilities of changing the emphasis because they have no standard functions capable of enlarging the sizes of the characters or changing the colors thereof.

Also, the portable communication terminals cannot transmit information regarding used fonts to base stations even though they support standard fonts and support a variety of fonts. The reason is that the format of a text message transmitted from each portable communication terminal to each base station does not have a field assigned to insert information containing descriptions of the fonts of edited characters therein.

Character information sending systems for providing various fonts using portable communication terminals are disclosed in Korean Patent Laid-open Publication Nos. 2001-0008728 and 2001-0042545, Japanese Patent Laid-open Publication Nos. 2000-287260 and 2001-245340, and European Patent Laid-open Publication No. 1069549. However, these character information sending systems are each configured to, whenever a font is required to be changed, receive font information provided from an external device and send the received font information to a destination device. For this reason, such a system entails the inconvenience of having to gain access to the font information provision device for each font change. Moreover, for the font change, an external font information storage device must be further provided in addition to a portable communication terminal, resulting in an increase in system construction cost.

### SUMMARY OF THE INVENTION

Therefore, the present invention has been made in view of the above problems, and it is an object of the present invention to provide a portable communication terminal which is capable of changing the fonts of characters on the basis of standard fonts as well as a font provided by a manufacturer of the terminal, so as to edit character data according to a user's desire, and a method for changing a character font using the same.

It is another object of the present invention to provide a portable communication terminal which is capable of receiving character data of fonts changed diversely according to a user's desire and displaying the received character data in fonts reflecting the user's desire, and a method for changing a character font using the same.

In accordance with one aspect of the present invention, the above and other objects can be accomplished by the provision of a portable communication terminal for sending character data selected and displayed on a screen to a destination device in response to an inputted command, comprising storage means for storing font information for changing of a font of the character data; font changing means for changing the font of the character data inputted or to be inputted on the basis of the font information in response to an inputted control signal; display means for displaying the font information and the character data of the font changed by the font changing means on the screen; communication means for communicating with the destination device, the communicating means sending the character data in the changed font by the font changing means and displayed on the screen to the destination device in response to an inputted control signal; and control means for controlling the font changing means in response to a font change command to change the font of the character data, and controlling a display operation of the display means and a sending operation of the communication means.

Preferably, the font information includes font style information, font size information and font color information changeable for the character data. The control means may receive additional font information provided from an external contents server for font information provision through the communication means and update the font information stored in the storage means with the received additional font information. Accordingly, the font changing means may change the font of the character data on the basis of the stored font information including the updated additional font information. Further, preferably, the control means, upon receiving a character data processing command, converts the character data into standardized specification values including descriptions of the font which can be recognized, decoded and displayed between a transmitting terminal and a receiving terminal. At this time, the control means sequentially converts the character data into the specification values in the order of a font style, a font size, a font color and characters of a preset basic font.

Preferably, if the font of the character data is not supportable by the font information, the font changing means decodes the font of the character data into the preset basic font. As a result, the control means controls the display means to display the character data of the decoded basic font on the screen.

Preferably, the portable communication terminal further comprises key input means including keys for inputting character data and changing a font of the character data. Namely, the key input means includes a short message function selection key, a character input key, a font setting key and a character processing key. The short message function selection key is provided to select a function of sending a short message to the destination device, and the character input key has a plurality of buttons for inputting characters to be sent. The font setting key is provided to change the font of a character to be inputted or the font of an inputted character through the font changing means, and the character processing key is provided to select a command for the sending and/or storage of an inputted character to the destination device and/or in the storage means.

In accordance with another aspect of the present invention, there is provided a method for changing a character font using a portable communication terminal, comprising the steps of a) determining whether a character has been inputted to be sent to a destination device; b), if the character is determined to have been inputted, displaying the inputted character on a screen in a preset font; c) determining whether a font changing menu has been selected to change a font of the inputted character or a font of a character to be inputted; d), if the font changing menu is determined to have been selected, displaying on the screen submenus available fonts are changeable according to font information including information regarding available fonts; e), if selection and change commands are applied to the submenus displayed on the screen, changing the font of the inputted character or the font of the character to be inputted; and f) displaying the inputted character on the screen in the changed font.

Preferably, the method further comprises the steps of g), while the inputted character is displayed in the changed font, determining whether a character sending menu has been selected to send the displayed character to the destination device; h), if the character sending menu is determined to have been selected, converting the displayed character into specification values recognizable between a transmitting terminal and a receiving terminal on the basis of the font information; and i) sending the converted specification values corresponding to the displayed character.

Preferably, the font information includes font style information, font size information and font color information changeable for the character. The method further including the step of sequentially converting the character into the specification values in the order of a font style, a font size, a font color and a character of a basic font.

In a feature of the present invention, besides a set basic font, a variety of fonts available according to a user's taste are provided for a character to be inputted or an inputted character, thereby enabling the user to edit characters to display greater individuality using the various fonts. Further, owing to the provision of a variety of available fonts for characters, a user-oriented character embellishment function can be performed as in a PC environment, so that additional services can be provided. Furthermore, upon receiving character data of fonts that are changed according to a user's intention at a transmitting terminal, a receiving terminal decodes the received character data on the basis of the changed fonts. Therefore, the receiving terminal can display the received character data in fonts reflecting the user's intention to edit the character data at the transmitting terminal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing a portable communication terminal having a character font changing function in accordance with a preferred embodiment of the present invention;

FIG. 2 is a detailed block diagram of a key input unit in FIG. 1;

FIG. 3 is a view on a screen showing a displayed state of inputted characters of fonts changed by a font changing unit in FIG. 1;

FIGS. 4a and 4b are views showing an example of the conversion of inputted characters into specification values when the inputted characters are sent;

FIG. 5 is a view showing an example of a converted format of an inputted character of a specific font when the inputted character is sent;

FIG. 6 is a flow chart illustrating a method for changing a character font using the portable communication terminal in accordance with a preferred embodiment of the present invention;

FIG. 7 is a flow chart illustrating a method for receiving a text message sent in FIG. 6 and decoding a character font of the received text message, using the portable communication terminal in accordance with a preferred embodiment of the present invention;

FIG. 8 is a flow chart illustrating in detail a decoding step in FIG. 7; and

FIG. 9 is a flow chart illustrating in detail steps A and B in FIG. 8.

### DETAILED DESCRIPTION OF THE PREFERRED EMBODIMENTS

Now, preferred embodiments of the present invention will be described in detail with reference to the annexed drawings.

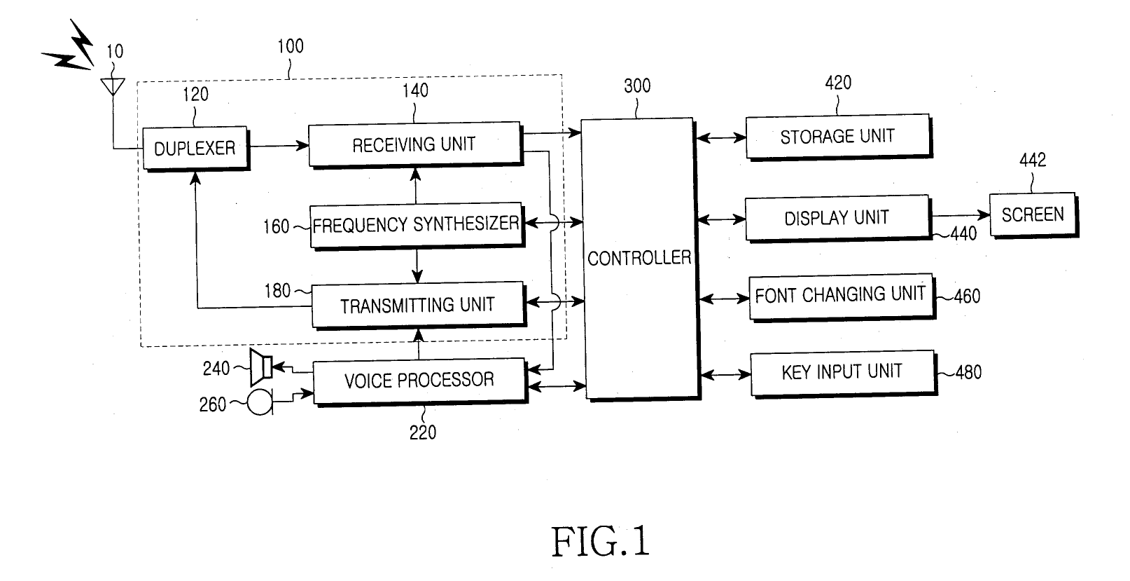

With reference to FIG. 1, there is shown in block form a preferred embodiment of a portable communication terminal having a character font changing function in accordance with the present invention. Before describing the present embodiment, a brief description will be given of a general construction of the portable communication terminal with reference to FIG. 1.

As shown in FIG. 1, the portable communication terminal comprises a communication unit 100, a voice processor 220, a controller 300, a storage unit 420, a display unit 440 and a key input unit 480.

The communication unit 100 provides communication functions with an external communication device and receives a short message and other character data and voice data transmitted from the external device. The voice processor 220 decodes an output signal from the communication unit 100, convert the decoded result into an electrical voice signal and outputs the converted voice signal to a speaker 240. The voice processor 220 also converts a voice signal received through a microphone 260 into an electrical signal, codes the converted signal and outputs the coded result to a transmitting unit 180 in the communication unit 100.

The controller 300 functions to control the entire operation of the portable communication terminal, including transmission and reception of signals for communication with the external device. The storage unit 420 is adapted to store a drive program necessary for the control of the controller 300 and data generated during the control thereof. The display unit 440 functions to display status information and/or operation information of the portable communication terminal on a screen 442 under the control of the controller 300. The key input unit 480 has a plurality of numeric and character keys, and serves to generate data corresponding to a selected one of the keys and transfer the generated data to the controller 300.

The communication unit 100 includes, as shown in FIG. 1, a duplexer 120, a receiving unit 140, a frequency synthesizer 160 and the transmitting unit 180.

The duplexer 120 acts to extract a signal of a predetermined frequency band from among signals received at an antenna 10 and output the extracted signal to the receiving unit 140. The duplexer 120 also transfers an output signal from the transmitting unit 180 to the antenna 10. The receiving unit 140 operates under the control of the controller 300 to transfer output data from the duplexer 120 to the voice processor 220, if it corresponds to a voice signal, and to the controller 300 if it does not correspond to a voice signal. The controller 300, is adapted to decode output data from the receiving unit 140 according to an algorithm based on an associated data characteristic.

The frequency synthesizer 160 acts to generate and output frequencies to the transmitting unit 180 and receiving unit 140, under the control of the controller 300. The transmitting unit 180 is adapted to convert an output signal from the voice processor 220 into a signal of a predetermined frequency band for transmission in response to an output signal from the frequency synthesizer 160.

The portable communication terminal according to the present embodiment further comprises a font changing unit 460 for changing the font of an inputted and displayed character in response to an inputted control signal. To this end, font information that can be changed by the font changing unit 460 is stored in the storage unit 420. Further, the key input unit 480 includes a font changing key (not shown) for outputting to the controller 300 a command for changing a character font according to the font information stored in the storage unit 420 in response to a selected signal. The controller 300 controls the font changing unit 460 in response to the character font change command from the font changing key such that the font changing unit 460 changes the font of a character to be inputted.

According to the present embodiment, the font information stored in the storage unit 420 includes information regarding character font styles, font sizes and font colors. As a result, the font changing unit 460 changes the font of a character to be inputted on the basis of the font information stored in the storage unit 420 under the control of the controller 300. At this time, the font changing unit 460 may selectively change the font of a character to be inputted or the font of an inputted character. Preferably, the font information stored in the storage unit 420 can be updated with additional font information provided from an external contents server for providing font information. In this case, the font changing unit 460 can utilize more character fonts through the use of the updated additional font information.

In other words, in the case where character data of a font not supported by the font information stored in the storage unit 420 is received, the controller 300 controls the display unit 440 and voice processor 220 to output a request message for updating of the stored font information with additional supportable font information from the contents server in a character and/or voice form.

The font information stored in the storage unit 420 can preferably be expressed by standardized specification values including descriptions of fonts which can be recognized and displayed among portable communication terminals. For example, font styles of the font information may be specified within the range of “0x8000” to “0x800f” and font sizes thereof may be specified within the range of “0x9000” to “0x900f”. Alternatively, a specification value just subsequent to a specification value “0x88” of the font information may be set to specify a font style if the specification value “0x88” is recognized, and a specification value just subsequent to a specification value “0x99” of the font information may be set to specify a font size if the specification value “0x99” is recognized. It is also preferred that the font information is stored in the storage unit 420 in the form of a look-up table (LUT). As a result, the font changing unit 460 changes the font of a character to be inputted on the basis of the specification values in the look-up table. Also, a receiving portable communication terminal decodes the font of a character, changed to corresponding specification values and sent by a transmitting portable communication terminal, on the basis of the specification values in the look-up table.

The controller 300 can send character font information changed by the font changing unit 460 to a destination device while inserting it in a specific field of inputted character data. Alternatively, the controller 300 may sequentially send the font information and the character data to the destination device in a serial manner.

According to the present embodiment, while a character input state is displayed on the screen 442, a user can select a font changing menu capable of changing a font style, font size and font color of a character.

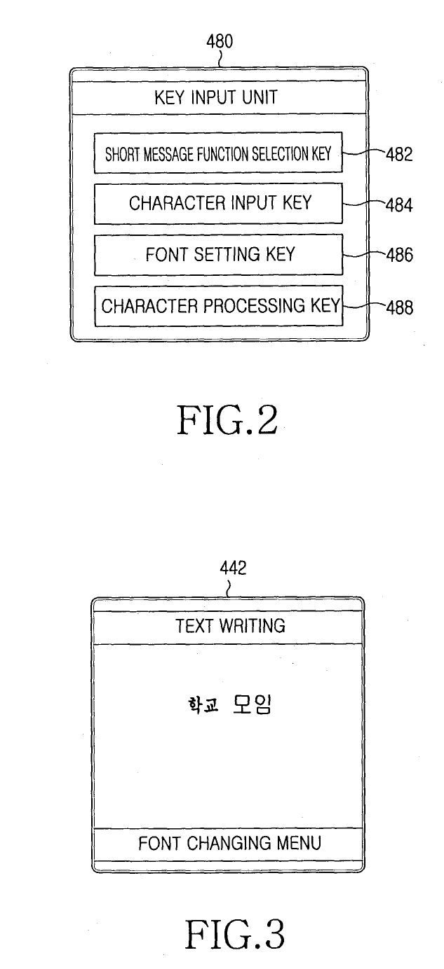

FIG. 2 is a detailed block diagram of the key input unit 480 in FIG. 1. As shown in this drawing, the key input unit 480 includes a short message function selection key 482, a character input key 484, a font setting key 486 and a character processing key 488. The short message function selection key 482 is provided to select a function of sending a short message to a destination device, and the character input key 484 has a plurality of buttons for inputting characters to be sent. The font setting key 486 is provided to change the font of a character to be inputted or the font of an inputted character through the font changing unit 460, and the character processing key 488 is provided to select a command for the sending and/or storage of an inputted character to a destination device and/or in the storage unit 420. If the user wishes to change the font of a character, he/she can change the character font to a desired font style, font size and font color by selecting the font setting key 486.

FIG. 3 shows displayed on the screen 442 a displayed state of inputted characters of fonts changed by the font changing unit 460 in FIG. 1. As seen from this drawing, in a text writing menu where characters can be inputted by the character input key 484, characters “ [symbol] (a Korean word signifying the English word ‘school’)” are changed to “GungsuhChe (a Korean font)” in font and inputted by the character input key 484, and characters “ [symbol] (a Korean word signifying the English word ‘meeting’)” are changed to “GulimChe (a Korean font)” in font and inputted by the character input key 484. Also, the inputted characters “ [symbol] ” and the inputted characters “ [symbol] ” have different font sizes. At this time, displayed on the screen 442 is the font changing menu where the fonts of inputted characters or the fonts of characters to be inputted can be changed. Accordingly, if the user wants to change a character font while inputting characters by the character input key 484, he/she can change the character font to a desired font by selecting the font changing menu displayed on the screen 442.

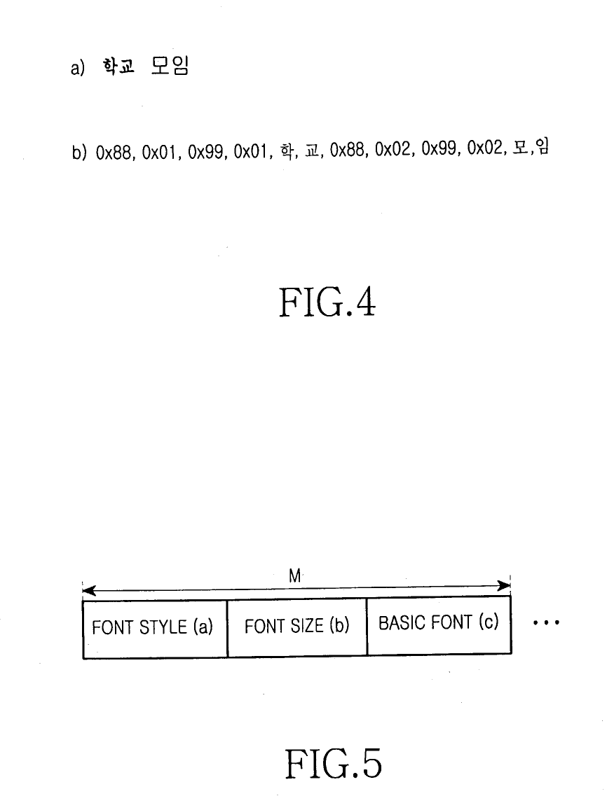

FIGS. 4a and 4b show an example of the conversion of inputted characters into specification values when the inputted characters are sent. FIG. 4a shows an inputted state of characters, as shown in FIG. 3, having different font sizes and different font styles. In this drawing, the inputted characters “ [symbol] ” are “10” in font size and “GungsuhChe” in font style, and the inputted characters “ [symbol] ” are “11” in font size and “GulimChe” in font style.

If the character processing key 488 is selected to send the characters inputted as stated above, then the controller 300 converts the inputted characters into specification values and sends the converted specification values to a destination device. FIG. 4b shows specification values into which the inputted characters are converted according to their fonts. In this drawing, a specification value of 1 byte indicated just subsequently to “0x88” specifies a character font style, and a specification value of 1 byte indicated just subsequently to “0x99” specifies a character font size. In the present embodiment, the specification value of 1 byte just subsequent to “0x88” is “0x01” when the character font style is “GungsuhChe”, and “0x02” when the character font style is “GulimChe”. Also, the specification value of 1 byte just subsequent to “0x99” is “0x01” when the character font size is “10”, and “0x02” when the character font size is “11”.

Accordingly, in order to send the inputted characters of the fonts shown in FIG. 4a, the controller 300 converts the inputted characters into “0x88, 0x01, 0x99, 0x01, [symbol] , 0x88, 0x02, 0x99, 0x02, [symbol] ” as shown in FIG. 4b according to the present embodiment and sends the converted results to a destination device.

FIG. 5 shows an example of a converted format of an inputted character of a specific font when the inputted character is sent. If a character inputted as shown in FIG. 4a is converted as shown in FIG. 4b by the controller 300, then it has a converted format M as shown in FIG. 5. The format M is sequentially composed of a font style field a, a font size field b and a basic font field c, which includes a character of a basic font. The basic font converted when the character is sent is a font defined to be recognizable among portable communication terminals. Where the inputted character includes color information, it is converted and sent in the order of “font style”, “font size”, “font color” and “basic font” by the controller 300. In case that there are a plurality of fonts recognizable among portable communication terminals, the basic font can be changed to any one of the recognizable fonts. Of course, the order of sent information can be varied depending on final configuration.

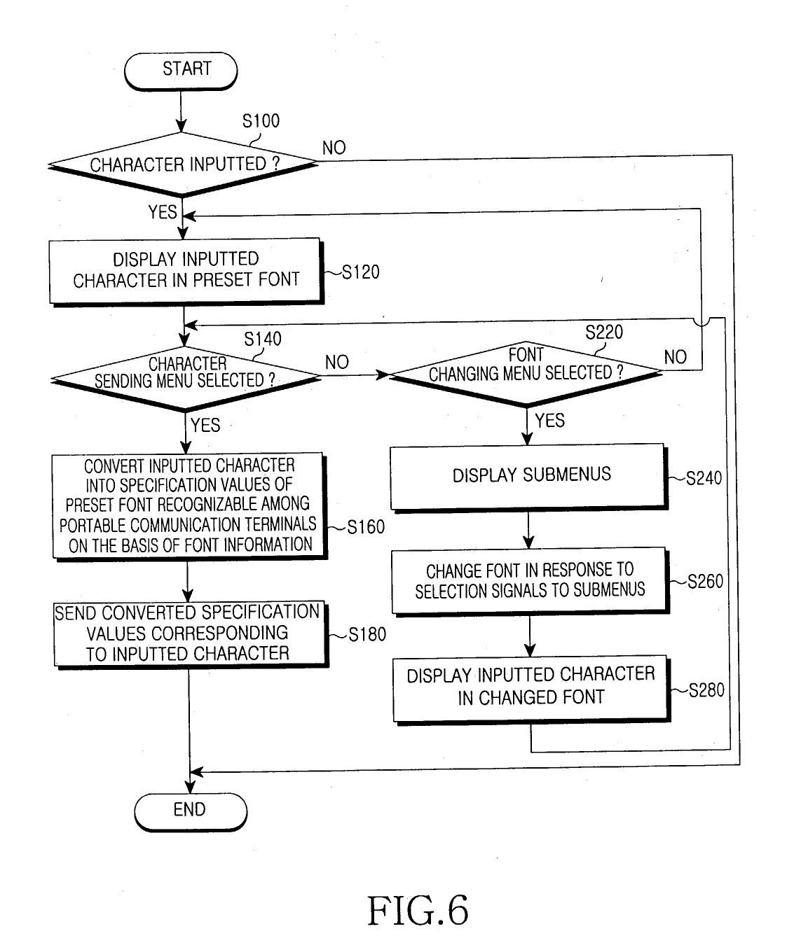

FIG. 6 is a flow chart illustrating a preferred embodiment of a method for changing a character font using the portable communication terminal in accordance with the present invention.

First, the controller 300 determines whether the character input key 484 has been selected to input a character to send a text message to a destination device (S 100). Upon determining that a character has been selected and inputted by the character input key 484, the controller 300 controls the display unit 440 to display the inputted character on the screen 442 in a preset font (S120). While the character is inputted by the character input key 484, the controller 300 determines whether a character sending menu has been selected to send the inputted character to the destination device as the character processing key 488 is selected (S 140).

If the character sending menu is determined to have been selected at the above step S140, then the controller 300 converts the inputted character into specification values of the preset font recognizable among portable communication terminals on the basis of the font information stored in the storage unit 420 (S 160). The controller 300 then sends the converted specification values corresponding to the inputted character (S 180).

On the other hand, in the case where it is determined at the above step S140 that the character sending menu has not been selected, the controller 300 determines whether the font changing menu has been selected to change the font of the inputted character or the font of a character to be inputted as the font setting key 486 is selected (S220). If the font changing menu is not selected, the process returns to S120. If the font changing menu is determined to have been selected, then the controller 300 displays on the screen 442 submenus in which fonts are changeable by the font changing unit 460 according to the font information stored in the storage unit 420 (S240). The submenus in which fonts are changeable according to the font information may be, for example, a font style changing menu, a font size changing menu, a font color changing menu, etc. If the submenus displayed on the screen 442 ire selected and applied with change commands, then the font changing unit 460 changes the font of the inputted character or the font of a character to be inputted (S260). As a result, the controller 300 controls the display unit 440 to display the inputted character on the screen 442 in a font changed by the font changing unit 460 (S280). While the inputted character is displayed in the changed font, the controller 300 also repeats step S140 of determining whether the character sending menu has been selected for the inputted character.

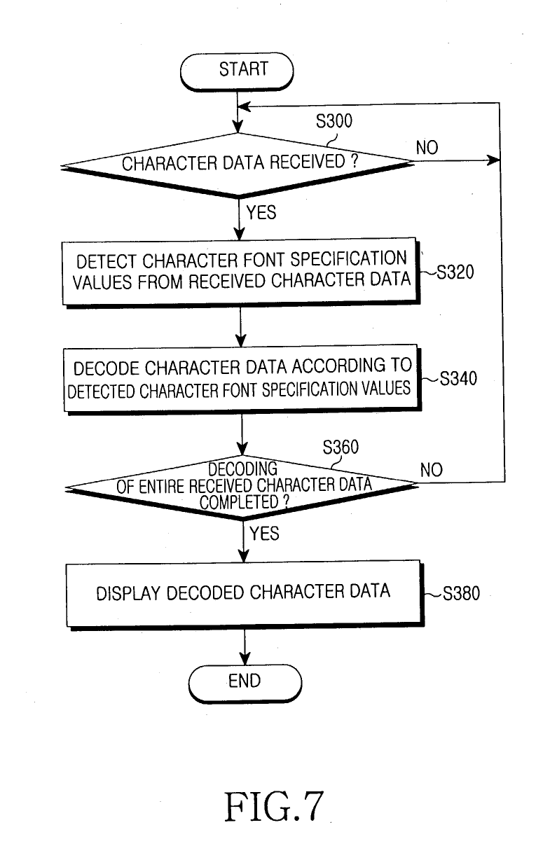

FIG. 7 is a flow chart illustrating a preferred embodiment of a method for receiving a text message sent in FIG. 6 and decoding a character font of the received text message, using the portable communication terminal in accordance with the present invention.

First, the controller 300 determines whether character data sent from an external device has been received (S300). If not, the process returns to S300. If character data is determined to have been received, then the controller 300 detects character font specification values from the received character data (S320). The font changing unit 460 decodes the received character data on the basis of the font information stored in the storage unit 420 according to the character font specification values detected by the controller 300 (S340).

Then, the controller 300 determines whether the decoding of the entire received character data has been completed by the font changing unit 460 (S360). If not, the process returns to S300. Upon determining that the decoding of the entire received character data has been completed, the controller 300 controls the display unit 440 to display the entire received character data decoded by the font changing unit 460 on the screen 442 (S380).

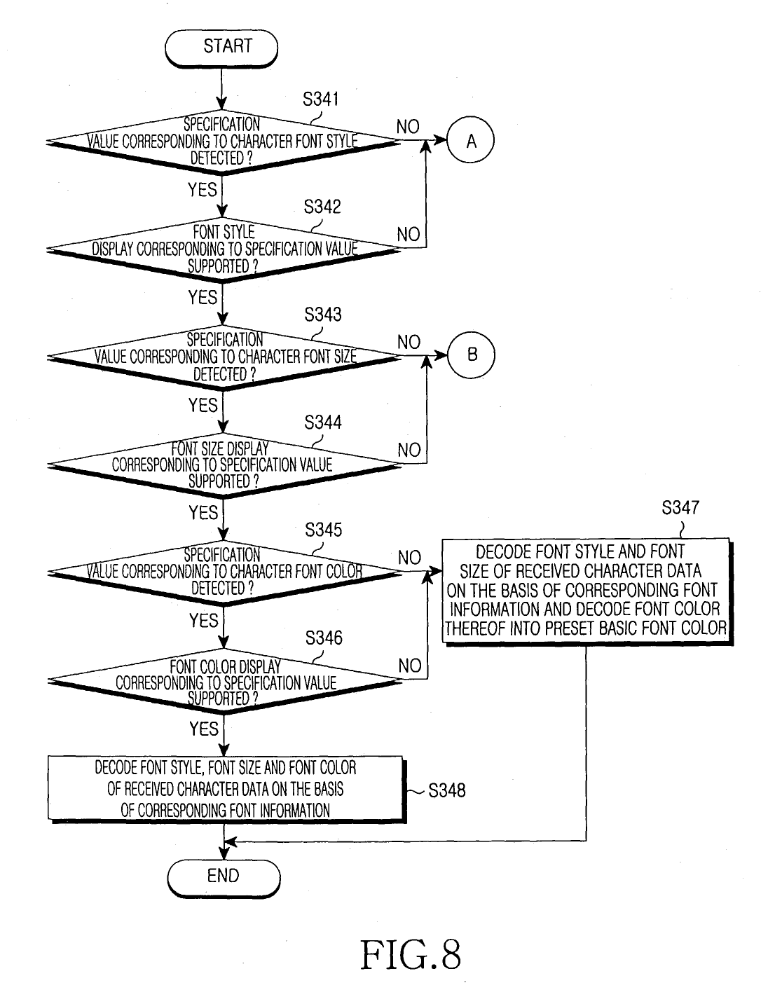

FIG. 8 is a flow chart illustrating in detail the decoding step S340 in FIG. 7. First, the font changing unit 460 determines whether a specification value corresponding to a character font style is present among the character font specification values detected by the controller 300 (S341). If a specification value corresponding to a character font style is determined to be present, then the font changing unit 460 determines whether font information corresponding to the specification value is present among the font information stored in the storage unit 420, so as to determine whether the received character data can be displayed (i.e., is supported) in the font style corresponding to the specification value (S342).

In the case where it is determined at the above step S342 that font information corresponding to the font style specification value is present among the font information stored in the storage unit 420 and the received character data can thus be displayed in the font style corresponding to the specification value, the font changing unit 460 determines whether a specification value corresponding to a character font size is present among the character font specification values detected by the controller 300 (S343). If a specification value corresponding to a character font size is determined to be present, then the font changing unit 460 determines whether font information corresponding to the font size specification value is present among the font information stored in the storage unit 420, so as to determine whether the received character data can be displayed (i.e., is supported) in the font size corresponding to the specification value (S344).

In the case where it is determined at the above step S344 that font information corresponding to the font size specification value is present among the font information stored in the storage unit 420 and the received character data can thus be displayed in the font size corresponding to the specification value, the font changing unit 460 determines whether a specification value corresponding to a character font color is present among the character font specification values detected by the controller 300 (S345). If a specification value corresponding to a character font color is determined to be present, then the font changing unit 460 determines whether font information corresponding to the font color specification value is present among the font information stored in the storage unit 420, so as to determine whether the received character data can be displayed (i.e., is supported) in the font color corresponding to the specification value (S346).

Upon determining at the above step S345 that no specification value corresponding to a character font color is present among the character font specification values detected by the controller 300, the font changing unit 460 decodes the font style and font size of the received character data on the basis of the corresponding font information stored in the storage unit 420 and decodes the font color thereof into a preset basic font color (S347). Also, if it is determined at the above step S346 that no font information corresponding to the font color specification value is present among the font information stored in the storage unit 420 and the received character data cannot thus be displayed in the font color corresponding to the specification value, then the font changing unit 460 proceeds to step S347 of decoding the font style and font size of the received character data on the basis of the corresponding font information stored in the storage unit 420 and decoding the font color thereof into the preset basic font color.

In the case where it is determined at the above step S346 that font information corresponding to the font color specification value is present among the font information stored in the storage unit 420 and the received character data can thus be displayed in the font color corresponding to the specification value, the font changing unit 460 decodes the font style, font size and font color of the received character data on the basis of the corresponding font information stored in the storage unit 420 (S348).

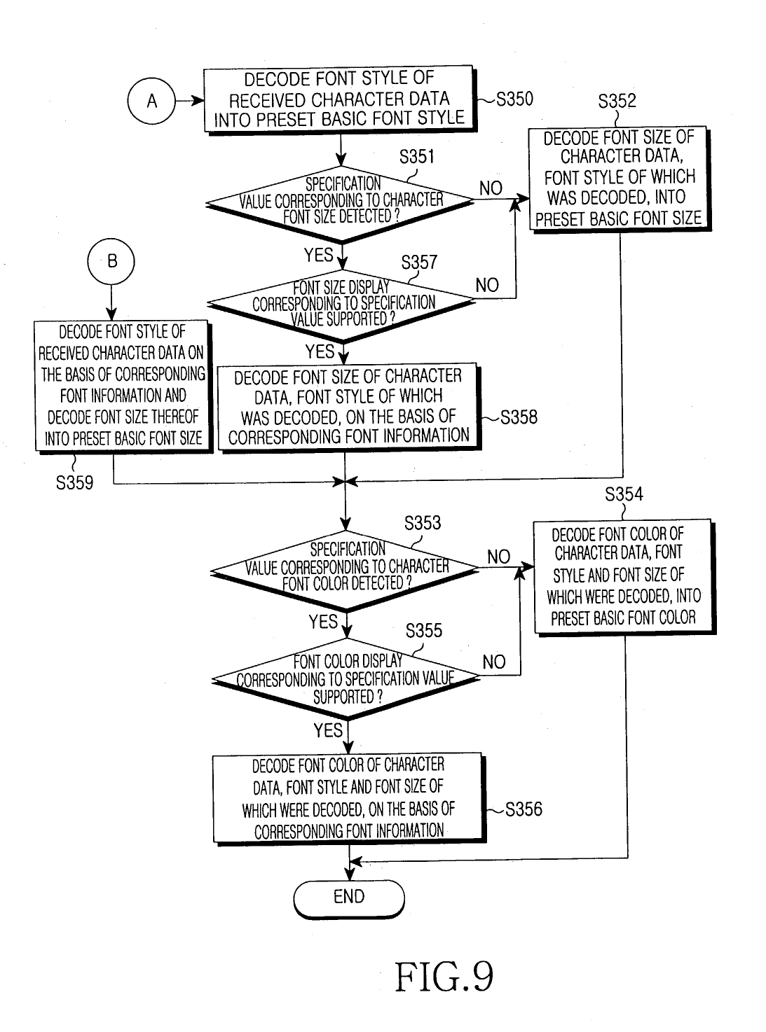

FIG. 9 is a flow chart illustrating in detail steps A and B in FIG. 8. First, if it is determined at step S341 in FIG. 8 that no specification value corresponding to a character font style is present among the character font specification values detected by the controller 300, then the font changing unit 460 decodes the font style of the received character data into a preset basic font style (S350).

Also, if it is determined at step S342 in FIG. 8 that no font information corresponding to the font style specification value is present among the font information stored in the storage unit 420 and the received character data cannot thus be displayed in the font style corresponding to the specification value, then the font changing unit 460 proceeds to step S350 of decoding the font style of the received character data into the preset basic font style.

After decoding the font style of the received character data into the preset basic font style, the font changing unit 460 determines whether a specification value corresponding to a character font size is present among the character font specification values detected by the controller 300 (S351). If a specification value corresponding to a character font size is determined to be present, then the font changing unit 460 determines whether font information corresponding to the font size specification value is present among the font information stored in the storage unit 420, so as to determine whether the received character data can be displayed in the font size corresponding to the specification value (S357).

In the case where it is determined at the above step S357 that the received character data can be displayed in the font size corresponding to the specification value, the font changing unit 460 decodes the font size of the received character data, the font style of which was decoded into the preset basic font style at step S350, on the basis of the corresponding font information stored in the storage unit 420 (S358).

After decoding the font style and font size of the received character data, the font changing unit 460 determines whether a specification value corresponding to a character font color is present among the character font specification values detected by the controller 300 (S353). If a specification value corresponding to a character font color is determined to be present among the character font specification values detected by the controller 300, then the font changing unit 460 determines whether font information corresponding to the font color specification value is present among the font information stored in the storage unit 420, so as to determine whether the received character data can be displayed in the font color corresponding to the specification value (S355). In the case where it is determined that font information corresponding to the font color specification value is present among the font information stored in the storage unit 420 and the received character data can thus be displayed in the font color corresponding to the specification value, the font changing unit 460 decodes the font color of the received character data, the font style and font size of which were decoded, on the basis of the corresponding font information stored in the storage unit 420 (S356).

On the other hand, if it is determined at the above step S351 that no specification value corresponding to a character font size is present, or if it is determined at the above step S357 that the received character data cannot be displayed in the font size corresponding to the specification value, then the font changing unit 460 decodes the font size of the received character data, the font style of which was decoded into the preset basic font style at step S350, into a preset basic font size (S352). This character data whose font size was decoded is further subjected to the decoding process of steps S353 to S356.

On the other hand, if it is determined at step S343 in FIG. 8 that no specification value corresponding to a character font size is present among the character font specification values detected by the controller 300, or if it is determined at step S344 in FIG. 8 that the received character data cannot be displayed in the font size corresponding to the specification value, then the font changing unit 460 decodes the font style of the received character data on the basis of the corresponding font information stored in the storage unit 420 and decodes the font size thereof into the preset basic font size (S359). This character data whose font size was decoded is further subjected to the decoding process of steps S353 to S356.

On the other hand, in case that a font selected in the submenus is not supportable, the controller 300 controls the display unit 440 nd voice processor 220 to output a request message for updating of the stored font information with additional supportable font information in a character and/or voice form. Thereafter, upon receiving an additional supportable font information update command responsive to the update request message, the controller 300 gains access to an external contents server for font information provision and receives additional font information provided from the contents server. The controller 300 then updates the font information stored in the storage unit 420 with the received additional font information. Hence, the font changing unit 460 can change the font of character data on the basis of the stored font information including the updated additional font information.

Next, a description will be given of an example of the operation of the portable communication terminal that receives and decodes specification values “0x88, 0x01, 0x99, 0x01, [symbol] , 0x88, 0x02, 0x99, 0x01, [symbol] ” shown in FIG 4b. Provided that the portable communication terminal can decode and display all characters changed to GungsuhChe and GulimChe in font style and to 10 and 11 in size, characters “ [symbol] ” whose font size and font style decoded by the font changing unit 460 are 10 and GungsuhChe, respectively, and characters “ [symbol] ” whose font size and font style decoded by the font changing unit 460 are 11 and GulimChe, respectively, are displayed on the screen 442. If the portable communication terminal determines that the characters changed to GungsuhChe in font style cannot be decoded and displayed on the screen 442, then it replaces the font style “GngsuhChe” recognized from “0x88 and 0x01” among the specification values with a basic font style set therein and displays the resulting characters on the screen 442. In the present embodiment, BatangChe (a Korean font) is set as the basic font style to be replaced when the font styles of received characters are not supportable.

As apparent from the above description, according to the present invention, besides a set basic font, a variety of available fonts according to a user's taste are provided for a character to be inputted or an inputted character, thereby enabling the user to edit characters to display greater individuality using the various fonts.

Further, owing to the provision of a variety of changeable fonts for characters, a user-oriented character embellishment function can be performed as in a PC environment, so that additional provided services can be more activated.

Moreover, upon receiving character data of fonts changed diversely according to a user's intention at a transmitting terminal, a receiving terminal decodes the received character data on the basis of the changed fonts. Therefore, the receiving terminal can display the received character data in fonts reflecting the user's intention to edit the character data at the transmitting terminal.

Although the preferred embodiments of the present invention have been disclosed for illustrative purposes, those skilled in the art will appreciate that various modifications, additions nd substitutions are possible, without departing from the scope and spirit of the invention as disclosed in the accompanying claims.

What is claimed is:

1. A portable communication terminal for sending character data selected and displayed on a screen to a destination device in response to an inputted command, comprising:
storage means for storing font information for changing of a font of said character data;
font changing means for changing said font of said character data inputted or to be inputted on the basis of said font information in response to an inputted control signal;
display means for displaying said font information and said character data in a font changed by said font changing means on said screen;
communication means for communicating with said destination device and for sending said character data in the changed font to said destination device in response to an inputted control signal; and
control means for controlling said font changing means in response to a font change command to change said font of said character data, and controlling a display operation of said display means, and controlling a sending operation of said communication means.

2. The portable communication terminal as set forth in claim 1, wherein said font information includes at least one of font style information, font size information and font color information for said character data.

3. The portable communication terminal as set forth in claim 2, wherein said control means is adapted to receive additional font information provided from an external contents server for providing font information through said communication means and updating said font information stored in said storage means with the received additional font information,
wherein said font changing means is adapted to change said font of said character data on the basis of said stored font information including the updated additional font information.

4. The portable communication terminal as set forth in claim 3, wherein said control means is adapted to, upon receiving a character data processing command, convert said character data into standardized specification values including descriptions of said font which can be recognized, decoded and displayed between the portable communication terminal and the destination device.

5. The portable communication terminal as set forth in claim 4, wherein said control means is adapted to sequentially convert said character data into said specification values in the order of a font style, a font size, a font color and characters of a preset basic font.

6. The portable communication terminal as set forth in claim 5, wherein said font changing means is adapted to, if said font of said character data is not supportable by said font information, decode said font of said character data into said preset basic font,
wherein said control means is adapted to control said display means to display said character data of the decoded basic font on said screen.

7. The portable communication terminal as set forth in claim 5, wherein said control means is adapted to, if said font of said character data is not supportable by said font information, control said display means and voice processing means to output a request message for updating of said font information with said additional supportable font information from said contents server in at least one of a character and voice form, said voice processing means amplifying and outputting a voice signal.

8. The portable communication terminal as set forth in claim 7, further comprising key input means, said key input means including at least one of:
a short message function selection key for selecting a function of sending a short message to said destination device;
a character input key having a plurality of buttons for inputting characters;
a font setting key for changing a font of a character to be inputted or a font of an inputted character through said font changing means; and
a character processing key for selecting a command for at least one of sending to said destination and storing in said storage means an inputted character.

9. A method for changing a character font using a portable communication terminal, comprising the steps of:
a) determining whether a character has been inputted for sending character data to a destination device;
b) if the character is determined to have been inputted, displaying the inputted character on a screen in a preset font;
c) determining whether a font changing menu has been selected to change a font of said inputted character or a font of a character to be inputted;
d) if the font changing menu is determined to have been selected, displaying on said screen submenus of available fonts according to font information including information regarding available fonts;
e) if selection and change commands are determined to have been selected, changing the font of said inputted character or the font of the character to be inputted; and
f) displaying said inputted character on said screen in the changed font.

10. The method as set forth in claim 9, further comprising the steps of:
g) while said inputted character is displayed in the changed font, determining whether a character sending menu has been selected to send said displayed character to said destination device;
h) if the character sending menu is determined to have been selected, converting said displayed character into specification values recognizable between the portable communication terminal and the destination device on the basis of said font information; and
i) sending to the destination device the converted specification values corresponding to the displayed character.

11. The method as set forth in claim 10, wherein said font information includes at least one of font style information, font size information and font color information changeable for said character.

12. The method as set forth in claim 11, wherein said step h) includes the step of sequentially converting said character into said specification values in the order of a font style, a font size, a font color and a character of a basic font.

13. The method as set forth in claim 12, further comprising the step
j) if said font of said character is a font selected in said submenus, which is not supportable, outputting a request message for updating of said font information with additional supportable font information in at least one of a character and voice form.

14. The method as set forth in claim 13, further comprising the steps of:
k) upon receiving an additional supportable font information update command responsive to said update request message, accessing an external contents server for providing font information and receiving additional font information provided from the contents server;
l) updating said font information with the received additional font information; and
m) changing said font of said character on the basis of said font information including the updated additional font information.
